(19) United States
(12) Patent Application Publication
(10) Pub. No.: US 2011/0166771 A1
(43) Pub. Date: Jul. 7, 2011

(54) FUEL CONTROL SYSTEM

(75) Inventors: Tateki Mitani, Chiyoda-ku (JP); Satoshi Nishikawa, Chiyoda-ku (JP); Shingo Iwai, Chiyoda-ku (JP)

(73) Assignee: MITSUBISHI ELECTRIC CORPORATION, Chiyoda-ku, Tokyo (JP)

(21) Appl. No.: 13/062,616

(22) PCT Filed: Oct. 29, 2008
(86) PCT No.: PCT/JP2008/069664

§ 371 Date: Mar. 7, 2011

(51) Int. Cl. F02D 41/30

(52) U.S. Cl. 701/104

(57) ABSTRACT

A fuel control system of the present invention is a fuel control system that controls a fuel injection quantity of an internal combustion engine by controlling combustion of a fuel at a theoretical air-fuel ratio, and is characterized in that the fuel control system estimates a volume of the fuel injection quantity from a measured refractive-index value of the fuel and controls it.

### TECHNICAL FIELD

The present invention relates to a fuel control system that controls a fuel injection quantity of an internal combustion engine according to a fuel property, or a fuel control system that optimally controls the fuel injection quantity according to an alcohol content in the internal combustion engine that uses a fuel having, for example, alcohol blended therein.

### BACKGROUND ART

In recent years, an FFV that uses a blended fuel, which has alcohol blended in gasoline, for an internal combustion engine of an automobile or the like has been developed and has already partly been used in practice. In the blended fuel, a correlation between a degree of heaviness of gasoline and a refractive index thereof varies depending on an alcohol concentration. Therefore, for realizing a theoretical air-fuel ratio in the blended fuel, it is necessary to accurately grasp the degree of heaviness of gasoline contained in the blended fuel and the alcohol concentration thereof so as to control a fuel injection quantity accordingly.

Therefore, a proposal has been made of a technology for measuring a photorefractive index, detecting the degree of heaviness of gasoline from the photorefractive index, determining a gasoline property correction coefficient Fgas, and controlling a fuel injection quantity using the correction coefficient (refer to patent document 1).

In addition, it has been proposed that: an optical transmittance which becomes an alcohol concentration index, and an refractive index which becomes a density (degree of heaviness) index are measured by an optical-system sensor; and a correlation between the degree of heaviness and refractive index is corrected according to an alcohol concentration (refer to patent document 2).

However, the foregoing ones make it necessary to measure two independent variables of a degree of heaviness and a refractive index. A measurement system cannot help becoming complex and expensive. In addition, the one using the optical-system sensor has a structural problem that adhesion of gasoline that dwells on a reflecting plate, or adhesion of mainly a gel component or a tar component of the gasoline adversely affects measurement precision.

In contrast, as a conventional system, there is one that measures a capacitance and a conductance so as to obtain an alcohol content (refer to patent document 3). However, this method is confronted with problems that since a density hypothetically remains constant, precision is poor, and that since it is necessary to increase the surface area of an electrode so as to improve sensitivity, a shape becomes large and the surface gets dirty to adversely affect a property.

Patent document 1: JP-A-6-17693

Patent document 2: JP-A-2008-107098

Patent document 3: JP-A-5-87764

### DISCLOSURE OF THE INVENTION

### Problems that the Invention is to Solve

Since all control approaches for a fuel injection quantity in conventional fuel control systems consider it as a precondition that theoretical air-fuel ratio control (A/F control) should be realized, a fuel quantity relative to the weight of an intake air quantity has to be determined in a weight. Therefore, it is necessary to hypothesize or actually measure a density (a degree of heaviness) of a fuel. The present invention addresses this point. An object of the present invention is to provide a novel fuel control system capable of obviating the necessity of hypothesizing or actually measuring the density (degree of heaviness) of a fuel, and highly precisely controlling a fuel injection quantity by measuring only the refractive index of the fuel.

### Means for Solving the Problems

A fuel control system of the present invention is a fuel control system that controls a fuel injection quantity of an internal combustion engine by controlling combustion of a fuel at a theoretical air-fuel ratio, and is characterized in that: the volume of the fuel injection quantity is calculated from a measured refractive-index value of the fuel; and theoretical air-fuel ratio control is performed based on the volume of the fuel injection quantity.

### ADVANTAGE OF THE INVENTION

A fuel control system in accordance with the present invention realizes a simple system capable of highly precisely obtaining an injection quantity according to a property of a fuel by measuring only a refractive index of the fuel, and realizing fuel injection quantity control by obviating the necessity of hypothesizing or actually measuring the density (degree of heaviness) of the fuel.

### BEST MODE FOR CARRYING OUT THE INVENTION

### Embodiment 1

A fuel control system in accordance with an embodiment of the present invention will be described below in conjunction with FIG. 1

An engine 1 shall be mounted in an FFV (flexible fuel vehicle) that operates with a blended fuel. A known construction is such that: the blended fuel contained in a fuel tank 2 is distributed to an injector 4 by a fuel pump 3; air externally taken in via an air cleaner 5 is controlled by a throttle valve 6 whose opening and closing are controlled by an acceleration pedal that is not shown, mixed with the fuel, and then injected into cylinders. Incidentally, exhaust gas from the engine 1 is emitted to outside by an exhaust system after being subjected to cleaning treatment through a catalyst 8.

A refractive index sensor 10 that measures a refractive index of a fuel is disposed on a fuel pipe 9 over which the fuel is fed to the engine 1. In addition, an air flow sensor 11 that measures an intake air quantity is disposed on a path of air to be taken in via the air cleaner 5, and an O2 sensor 12 that measures a combustive state is disposed on the exhaust system 7. Further, the present system includes a computer 13 normally called an ECU. Signals are inputted into the ECU from the various types of sensors 10 to 12 and subjected to predetermined calculation processing, signals for various types of actuators are produced.

The computer 13 is a known one including a CPU, a RAM, a ROM, and so on, and preserves data, which represents a relationship between a refractive index and a request injection quantity which will be described later (refractive index/request injection quantity data), in the form of a map or an expression. The refractive index/request injection quantity data is used based on theoretical air-fuel ratio control instruction (normally performed automatically) to determine a necessary request injection quantity. FIG. 2 shows a routine of the computer 13 due to theoretical air-fuel ratio control in the form of a flowchart. The routine will be described below.

For example, when a key switch that is not shown is turned on, or when a fuel is fed to the fuel tank 2, the routine is started with the timing as a trigger signal (S20). Refractive index/request injection quantity data is read from a value of refractive index measurement (S21) performed by the refractive index sensor 10 according to predetermined theoretical air-fuel ratio control instruction (S22). At the same time, a real request injection quantity dependent on a driven state of a vehicle is determined in a volume (cc) using a value of intake air quantity measurement (S24) done by the air flow sensor 11 in combination, and a valve opening time for the injector 4 is determined based on the real request injection quantity (S26). Incidentally, the injected fuel is combusted and expanded in the engine 1, the combustive state is monitored by the O2 sensor 12 lying on the exhaust system 7, and feedback control is achieved so that optimal combustion can be realized.

As the blended fuel, the one that has, for example, alcohol contained in a base gasoline at an appropriate content percentage shall be utilized. Assuming that blended gasolines obtained using ethanol as alcohol to be blended with three presumable kinds of gasolines of respective degrees of heaviness are employed, the results of simulation of calculating a request injection quantity (@air=10 g) from a refractive index on the basis of a combustion heat (J/cc) will be described below.

FIG. 3 is a diagram of simulation of calculating a request injection quantity (@air=10 g) from a refractive index on the basis of a total combustion heat (J/cc), wherein refractive indices of various types of gasolines, densities thereof, theoretical air-fuel ratios thereof, total combustion heats (J/g) per unit weight thereof, total combustion heats (J/cc) per unit volume thereof, total combustion heats (J) thereof in a case where combustion is achieved with 10 g of air at a theoretical air-fuel ratio, and request injection quantities (cc and g) thereof in a case where combustion is achieved with 10 g of air at the theoretical air-fuel ratio are listed. Therein, the theoretical air-fuel ratio is hypothetically thought to have no dependency on a degree of heaviness of a base gasoline, and the total combustion heat (J/g) is hypothetically thought to be proportional to the theoretical air-fuel ratio (=oxygen quantity). As a value of the total combustion heat (J), a lower combustion heat is adopted. The request injection quantity employed herein signifies a fuel quantity necessary to achieve combustion with 10 g of air at the theoretical air-fuel ratio. As a density of ethanol, the theoretical air-fuel ratio, and the total combustion heat (J/g) per unit weight, known numerical values shall be adopted.

In the drawing, the refractive indices of gasolines A to C and the densities thereof are hypothesized to be values each presumable within a range of a variance among locally procurable gasolines including heavy and light gasolines. The gasoline A is presumably light, the gasoline B is presumably average, and the gasoline C is presumably heavy. As for the theoretical air-fuel ratios of the gasolines A to C and the total combustion heats (J/g) per unit weight thereof, since a variance dependent on a gasoline property is thought to be limited, mean values among locally procurable gasolines, that is, a theoretical air-fuel ratio of 14.7 and a total combustion heat of 45000 (J/g) per unit weight are used in common.

The refractive indices of various kinds of ethanol contained gasolines, densities thereof, theoretical air-fuel ratios thereof, and total combustion heats (J/g) per unit weight thereof are numerical values each obtained by performing proportional averaging using a volume ratio of each ethanol contained component. As for ethanol concentrations, three concentrations of 25%, 50%, and 75% are adopted for all the gasolines A to C.

The total combustion heat (J/cc) per unit volume is converted as presented below using the total combustion heat (J/g) per unit weight and the density.

Total combustion heat (J/cc)=total combustion heat (J/g)×density

The request injection quantity volume (cc) per 10 g of air of each of various kinds of ethanol contained gasolines is calculated as presented below using the theoretical air-fuel ratio and density which are obtained through proportional averaging.

Request injection quantity (cc)=10/theoretical air-fuel ratio/density

In addition, the request injection quantity weight (g) per 10% of air of each of various kinds of ethanol contained gasolines is calculated as presented below using the theoretical air-fuel ratio obtained through proportional averaging.

Request injection quantity (g)=10/theoretical fuel-air ratio

The total combustion heat (J) in a case where combustion is achieved with 10 g of air at the theoretical air-fuel ratio is calculated as follows:

Total combustion heat (J)=total combustion heat (J/cc)×request injection quantity (cc)=total combustion heat (J/g)×10/theoretical air-fuel ratio

Now, the embodiment 1 of the present invention will be described based on the foregoing results of simulation.

FIG. 4 is what has the relationship between the density and refractive index in FIG. 3 plotted with respect to the gasolines A to C and blended fuels (E75, E50, E25, and E0) of the gasolines and ethanol. As for a base gasoline (ethanol content 0, that is, E0), the density and refractive index have a positive proportional relationship. As the refractive index is larger, the density tends to get larger. Since ethanol has a smaller refractive index and a larger density than the base gasoline does, when the ethanol concentration is larger, the density gets larger and the refractive index gets smaller. Namely, the density and refractive index inversely correlate to the ethanol concentration. Due to a variance among gasoline properties A to C, the refractive indices and densities are seen exhibit distributions with respect to the same ethanol concentration. Since ethanol includes a single component, as the ethanol concentration gets higher, variances among the refractive indices and densities decrease. Therefore, when an attempt is made to estimate the ethanol concentration from a measured refractive-index value, an ethanol concentration estimation error reflecting the refractive index variance takes place.

FIG. 5 is what has the relationship between the request injection quantity (g), which is defined in the weight of a fuel quantity necessary to achieve combustion with 10 g of air at a theoretical air-fuel ratio, and a refractive index plotted with respect to the gasolines A to C and the blended fuels of the gasolines A to C and ethanol. For the ethanol blended fuels of the same base gasoline, as the refractive index is smaller, the request injection quantity (g) monotonously increases. In the drawing, the theoretical air-fuel ratio for the three kinds of base gasolines A to C hypothetically remains constant. Therefore, as long as the ethanol concentration remains unchanged, the request injection quantity (g) takes on the same value irrespective of the refractive index. In contrast, since the refractive index varies depending on the base gasoline, if ethanol is blended, a variance occurs in the fuel refractive index. Therefore, when an attempt is made to estimate the request injection quantity (g) from a measured refractive-index value, an error identical to that in the case of ethanol concentration estimation takes place.

FIG. 6 is what has a refractive index and a request injection quantity volume (cc) plotted on the axis of abscissas and the axis of ordinates respectively with respect to blended fuels of ethanol and the base gasolines A to C. It is seen that data items in a case where the different base gasolines have the same ethanol concentration do not represent a certain value that does not depend on the refractive index, but exhibit refractive-index dependency while reflecting a difference in a density. As a result, compared with FIG. 5, FIG. 6 demonstrates that a variance in the request injection quantity (cc) relative to the refractive index is decreased, and that a variance in the refractive index is corrected due to a density difference of the base gasolines from one another. Thus, it is seen that as long as a calibration curve having the request injection quantity (cc), which has a variance thereof among the base gasolines averaged, plotted with respect to the refractive index is employed, the request injection quantity (cc) can be successfully estimated from the measured refractive-index value.

This is attributable to the presence of refractive-index dependency between the fact that as the density of a base gasoline is smaller, a fuel volume for realizing a theoretical air-fuel ratio gets larger and a refractive index gets smaller, and the fact that as an ethanol concentration is higher, the fuel volume for realizing the theoretical air-fuel ratio gets larger and the refractive index gets smaller. Therefore, once the refractive index is learned, the fuel volume for realizing the theoretical air-fuel ratio can be readily estimated without precise measurement of the ethanol concentration of a fuel.

The aforesaid results of simulation demonstrate that after a refractive index is measured, if a volume of an optimal injection quantity matched with the refractive index is calculated from predetermined data, and controlled with an injector valve opening time, theoretical air-fuel ratio control can be readily accomplished.

Using real gasolines and ethanol blended gasolines, refractive indices and densities were measured. As base gasolines, gasolines D and E that have a large difference between the refractive indices thereof are selected, and results of blending the gasolines with ethanol at a predetermined volume ratio are as shown in FIG. 7. Based on the data, a request injection quantity volume (cc) per 10 g of air of each of various kinds of ethanol contained gasolines is calculated as presented below on the assumption that a theoretical air-fuel ratio remains unchanged irrespective of a gasoline property.

Request injection quantity (cc)=10/theoretical air-fuel ratio/density

A result of plotting is shown in FIG. 8.

FIG. 8 verifies that the request injection quantity volume (cc) monotonously changes with respect to the refractive index similarly to the results of simulation shown in FIG. 6. A curve obtained by fitting the data is used as calibration data, whereby the request injection quantity volume (cc) can be estimated from a measured refractive-index value even for an ethanol blended fuel of an unknown ethanol concentration.

For refractive index measurement, an optical fiber having a grating formed on a core thereof is utilized, and the fact that a cladding mode spectrum of the grating varies depending on a liquid refractive index around a cladding is utilized. In addition, if an optical fiber refractive index sensor of a type that senses a transmitted light volume change of the optical fiber grating is employed, a high-precision measured refractive-index value is obtained (refer to WO 2006/126468AI).

Incidentally, a means for measuring a refractive index is not limited to the above one. Needless to say, a known means for measuring a refractive index by detecting a change in a refraction angle of obliquely incident light using a position detection type photodetector can be utilized.

In a type of sensor that adopts a capacitive sensor so as to measure an ethanol concentration on the basis of a dielectric constant difference between ethanol and a base gasoline, since an ethanol concentration can be sensed, a request injection quantity weight (g) can be estimated. However, since the density of an ethanol blended fuel varies while reflecting a variance in a density of a base gasoline, if a predetermined fuel volume is injected while being controlled with an injector valve opening time, a deviation from a theoretical air-fuel ratio due to the density variance takes place.

In addition, even when a type of sensor that senses an ethanol concentration on the basis of an absorbance difference between ethanol and a base gasoline is employed, a deviation from a theoretical air-fuel ratio due to the density variance also takes place. A method of estimating a fuel density using a sensor, which senses a refractive index of a fuel, in combination, and thus decreasing the deviation from the theoretical air-fuel ratio has been discussed. However, since plural sensors are employed, a construction becomes complex and a cost increases.

In contrast, the present invention estimates and controls a request injection quantity volume (cc) using only a refractive index sensor, and therefore has the merit that the construction can be simplified and the cost can be reduced.

### BRIEF DESCRIPTION OF THE DRAWINGS

FIG. 1 is an overall configuration diagram showing a fuel control system of an embodiment 1 in accordance with the present invention;

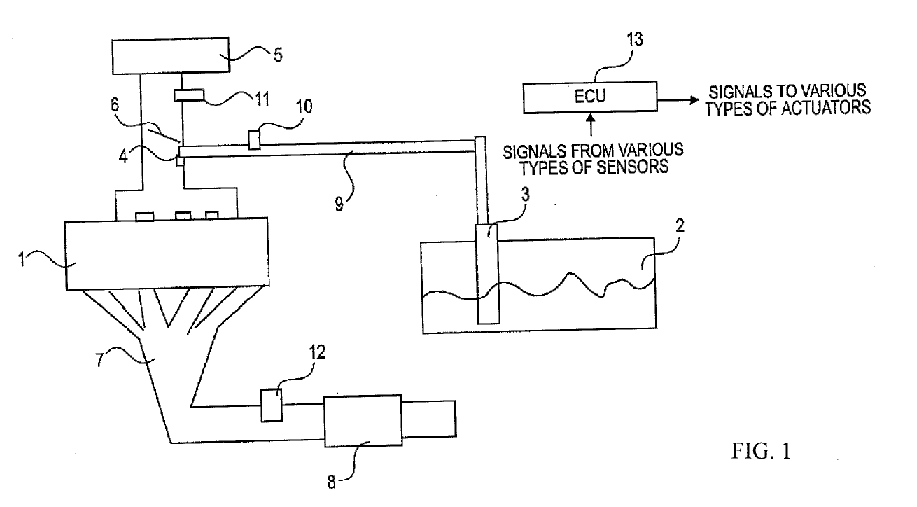

FIG. 2 is a flowchart describing a routine of a computer shown in FIG. 1;

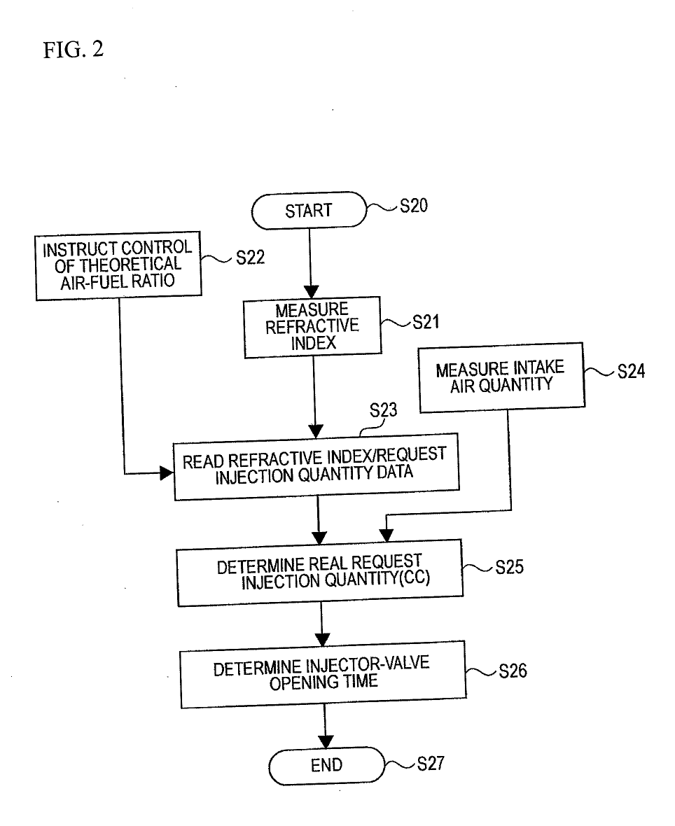

FIG. 3 is a diagram of simulation for calculating a request injection quantity from a refractive index in the embodiment 1 on the basis of a combustion heat;

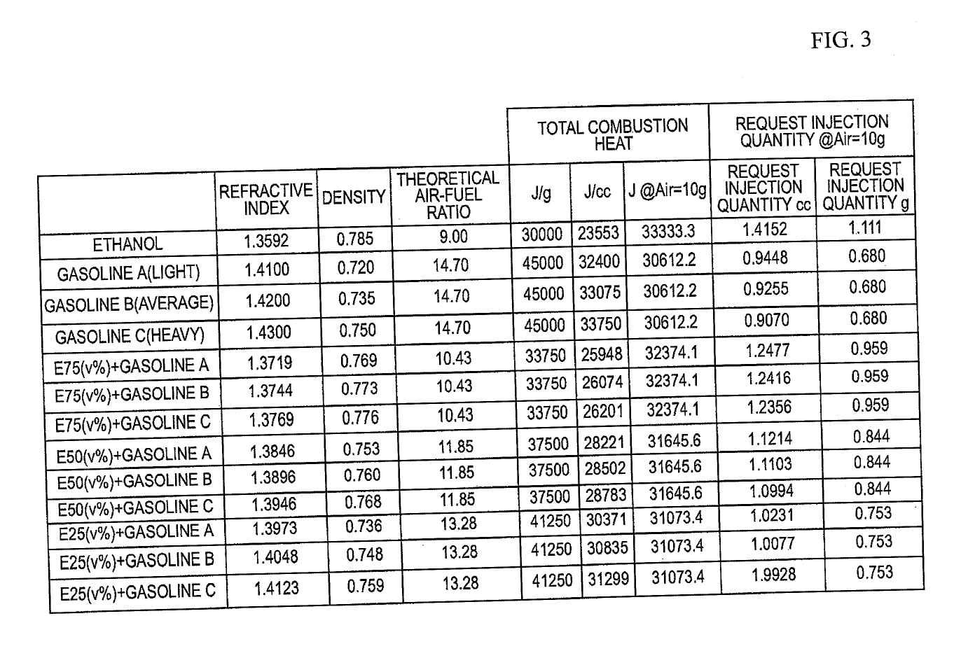

FIG. 4 is what has the relationship between a density and a refractive index plotted from FIG. 3 with respect to gasolines A to C and blended fuels of the gasolines and ethanol (E75, E50, E25, and E0);

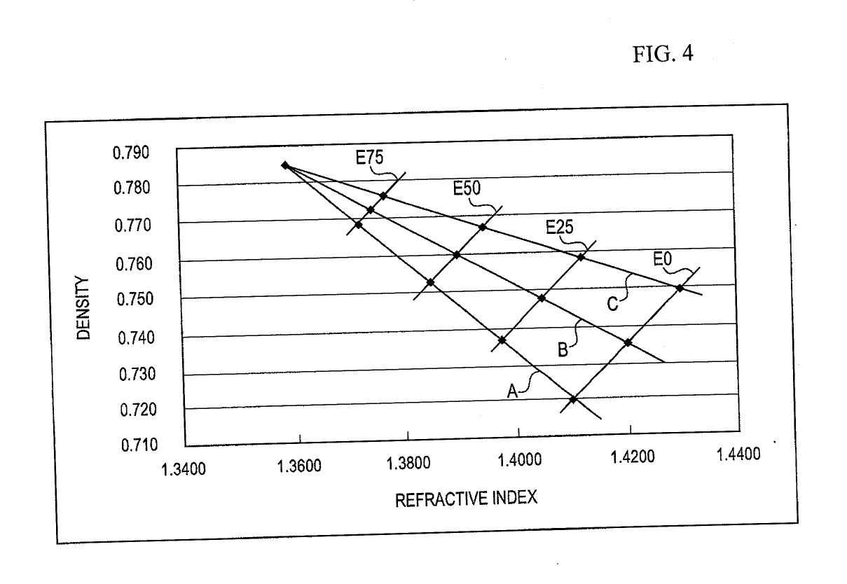

FIG. 5 is what has the relationship between the request injection quantity (g) and refractive index plotted from FIG. 3 with respect to the gasolines A to C and the blended fuels of the gasolines and ethanol;

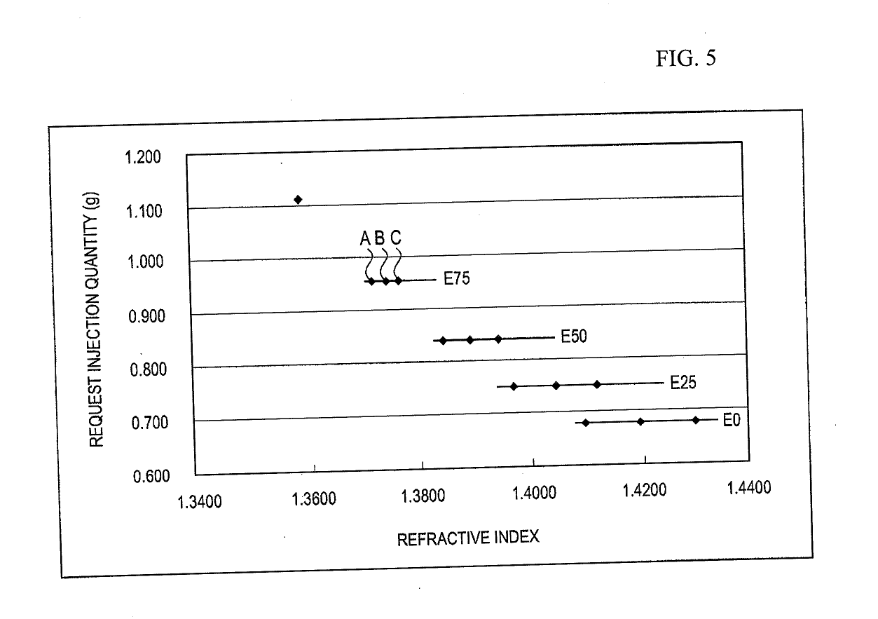

FIG. 6 is what has the relationship between the refractive index and request injection quantity volume (cc) plotted from FIG. 3 with respect to the blended fuels of ethanol and the base gasolines A to C;

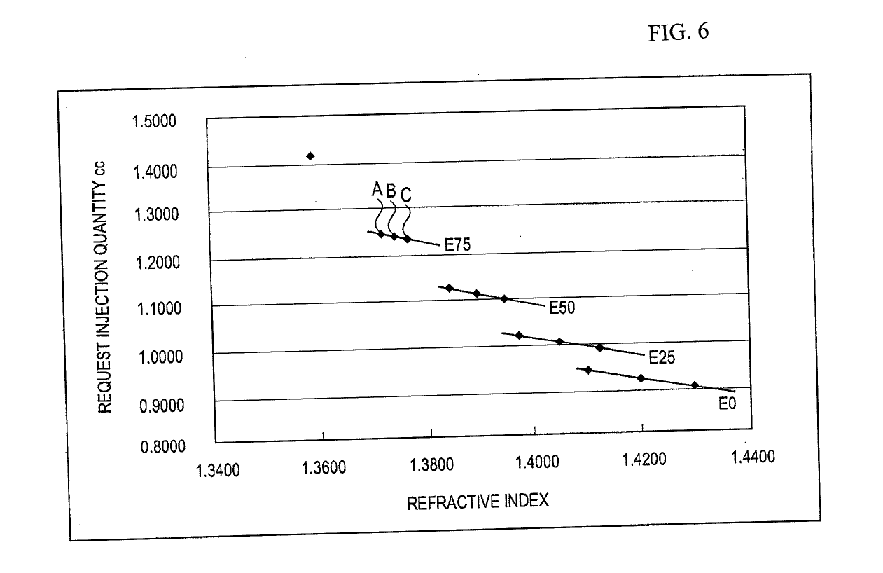

FIG. 7 is a table listing measured values obtained by performing measurement on real gasolines D and E and ethanol blended gasolines of the gasolines; and

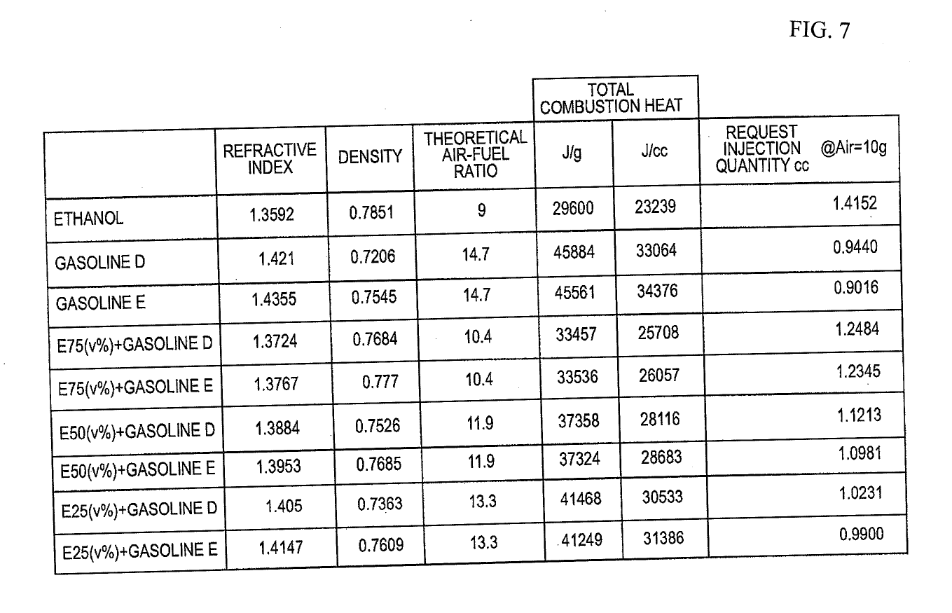

FIG. 8 is what has the relationship between the refractive index and request injection quantity volume (cc) plotted from FIG. 7 with respect to the blended fuels of ethanol and the base gasolines D and E.

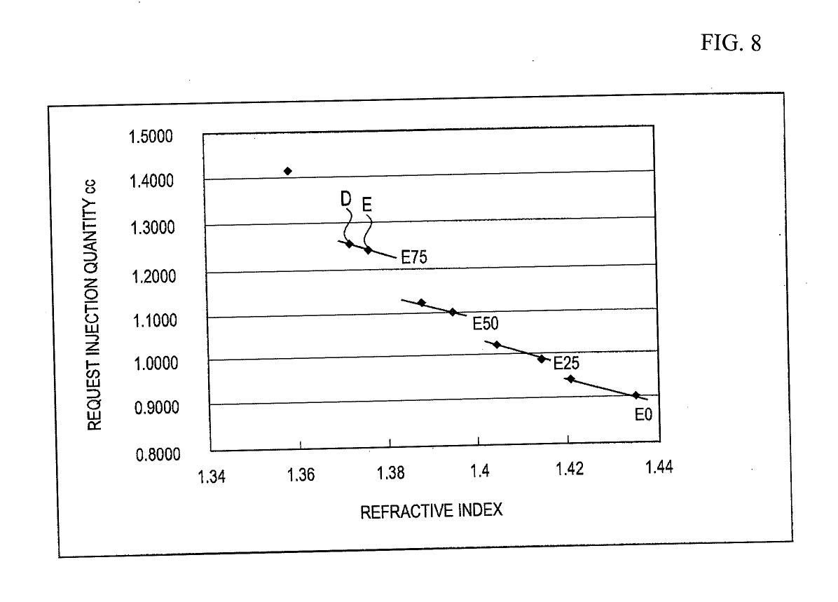

### DESCRIPTION OF REFERENCE NUMERALS

1: engine, 2: fuel tank, 3: fuel pump, 4: injector, 5: air cleaner, 6: throttle valve, 7: exhaust system, 8: catalyst, 9: fuel pipe, 10: refractive index sensor, 11: air flow sensor, 12: O2 sensor, 13: computer.

1.-9. (canceled)

10. A fuel control system that controls a fuel injection quantity of an internal combustion engine by controlling combustion of a fuel at a theoretical air-fuel ratio, characterized in that:
a volume of the fuel injection quantity is calculated from a measured refractive-index value of the fuel, and theoretical air-fuel ratio control is performed based on the volume of the fuel injection quantity.

11. The fuel control system according to claim 10, characterized in that the fuel used for the internal combustion engine is a blended fuel of gasoline and alcohol.

12. The fuel control system according to claim 11, characterized in that the alcohol is ethanol and a quantity thereof contained in the fuel is equivalent to a volume ratio ranging from 0 to 100%.

13. The fuel control system according to claim 10, characterized in that:
the fuel is a blended fuel containing a base gasoline and alcohol;
the refractive index of the fuel has a proportional relationship to each of a base gasoline density and an alcohol concentration; and
for various blended fuels that are different from one another in the base gasoline density and alcohol concentration, a volume of a request injection quantity defined as a fuel quantity requested for combustion at a theoretical air-fuel ratio is estimated from a measured refractive-index value of the fuel and controlled.

14. The fuel control system according to claim 10, characterized in that the fuel control system comprises:
a refractive index sensor that measures a refractive index of a blended fuel fed from a fuel tank to an internal combustion engine;
an air flow sensor that measures an intake air quantity for the internal combustion engine;
a memory means that preserves data concerning a refractive index/request injection quantity;
a means for reading an output of the refractive index sensor and determining a request injection quantity per unit air quantity from the preserved data concerning the refractive index/request injection quantity; and
a means for reading an output of the air flow sensor and converting the request injection quantity to a real request injection quantity.

15. The fuel control system according to claim 14, characterized in that:
the refractive index/request injection quantity data is read from the value of refractive-index value measurement done by the refractive index sensor through predetermined theoretical air-fuel ratio control;
a real request injection quantity dependent on a driven state of a vehicle is concurrently determined in a volume using in combination with a value of intake air quantity measurement done by the air flow sensor; and
an injector valve opening time is determined based on the real request injection quantity.

16. The fuel control system according to claim 14, characterized in that the request injection quantity is determined with a fuel quantity necessary to achieve combustion with an air quantity of a certain weight at a theoretical air-fuel ratio.

17. The fuel control system according to claim 15, characterized in that the request injection quantity is determined with a fuel quantity necessary to achieve combustion with an air quantity of a certain weight at a theoretical air-fuel ratio.

18. The fuel control system according to claim 10, characterized in that an optical fiber is employed in measurement of the refractive index.

19. The fuel control system according to claim 18, characterized in that the optical fiber has a core, on which a grating is formed, and a cladding, and includes a light source that causes light to fall on the optical fiber, and a light receiving element that detects a total light intensity of light that falls from the light source on the optical fiber and is transmitted by the grating.
